(19) United States
(12) Patent Application Publication
(10) Pub. No.: US 2021/0008895 A1
(43) Pub. Date: Jan. 14, 2021

(54) APPLY THERMAL ENERGY TO SUB-LINES

(71) Applicant: Hewlett-Packard Development Company, L.P., Spring, TX (US)

(72) Inventors: Jay S Gondek, Vancouver, WA (US); Jason M Quintana, Vancouver, WA (US)

(21) Appl. No.: 16/981,418

(22) PCT Filed: Apr. 30, 2018
(86) PCT No.: PCT/US2018/030296

§ 371 Date: Sep. 16, 2020

(51) Int. Cl. B41J 2/36

(52) U.S. Cl. CPC B41J 2/36

(57) ABSTRACT

Example implementations applying thermal energy to sub-lines. In some examples, a printing device can include a processing resource and a memory resource storing non-transitory machine-readable instructions to cause the processing resource to receive print data about a line to be formed on a thermally activated print medium, divide the line into a plurality of sub-lines, determine a threshold colorant density level of a first sub-line and a third sub-line of the plurality of sub-lines based on the received print data, and cause a print head of the printing device to apply thermal energy to the first sub-line and the third sub-line on the thermally activated print medium using the received print data.

### BACKGROUND

An imaging device, such as a printer, may be used to form markings on a physical medium. For example, the printer may receive print data corresponding to text and/or images and may use the received print data to form markings on the physical medium. One technique for forming markings on a medium includes the use of a thermally activated print media, and applying an appropriate amount of thermal energy to desired portions of the thermally activated print media.

### BRIEF DESCRIPTION OF THE DRAWINGS

FIG. 1 is a diagram of an example system to apply thermal energy to sub-lines consistent with the disclosure.

FIG. 2 is a diagram of an example of a thermally activated print medium consistent with the disclosure.

FIG. 3 is a diagram of an example controller to apply thermal energy to sub-lines consistent with the disclosure.

FIG. 4 is an example of a method to apply thermal energy to sub-lines consistent with the disclosure.

### DETAILED DESCRIPTION

Some printers may utilize thermal energy to form markings on a print medium. For example, a thermal printer may form markings on a print medium by applying thermal energy to portions of the print medium. As used herein, the term “thermal printer” refers to any hardware device with functionalities to physically produce representations (e.g., text, images, etc.) of print data on a medium via application of thermal energy to the print medium. In some examples, a “medium” may include a thermally activated print medium. The print data may comprise signals and/or states corresponding markings (e.g., images, text, etc.) to be formed on a single print medium, or across multiple print media (e.g., pages).

While a number of print media are contemplated by the present disclosure, one example of print media may include a stack of layers, the layers corresponding to a different color and activating in response to different temperatures, temperature durations, etc. For instance, in one case, a thermal printer can apply thermal energy at various temperatures to a thermally activated print medium to cause different layers of the thermally activated print medium to activate. For example, in one implementation, the thermally activated print medium can include a top yellow layer, a middle magenta layer, and a bottom cyan layer. The thermal printer can apply thermal energy at a first temperature to activate the yellow layer, thermal energy at a second temperature to activate the magenta layer, and thermal energy at a third temperature to activate the cyan layer. For instance, the thermal printer can apply thermal energy at, for example, 100° C. so that the heat penetrates the yellow and magenta layers and activates the cyan layer.

As used herein, the term “activate a layer” refers to production of a visible color of the thermally activated print medium as a result of an application of thermal energy to a location on the thermally activated print medium. In one case, print media usable for thermal printing may comprise chemicals that may react to the application of thermal energy by producing a visible color. For instance, the thermally activated print medium can include layers including colorless crystals of amorphochromic dyes. The amorphochromic dyes can produce a visible color when melted (e.g., due to application of thermal energy) and retain color after re-solidification.

Application of thermal energy to the point of the dyes melting to produce the visible color can be referred to as colorant startup. As used herein, the term “colorant startup” refers to a condition at which a particular layer of the thermally activated print medium produces a visible color. The conditions can include, for example, a temperature and/or duration of the application of thermal energy to the thermally activated print medium, relative humidity, etc.

In some instances, the conditions at which colorant startup occurs can vary, For example, the application of thermal energy to the thermally activated print medium to cause colorant startup can vary between different thermal printers, can vary between layers of the thermally activated print medium, and/or can be affected by outside factors such as relative humidity, etc.

Inconsistency in colorant startup can cause undesired effects. One such effect can include blown up highlights where no color is formed on the thermally activated print medium. The blown up highlights can result in no color being formed where a subtle color is supposed to be formed. For instance, when lighter colors such as a light blue are to be formed on the thermally activated print medium, thermal energy can be applied to the thermally activated print medium at a particular temperature and for a particular duration to activate, for example, the cyan layer. In some instances, the particular temperature for the particular duration may not consistently activate the cyan layer, which can result in inconsistent colors, such as different shades of light blue, or no light blue being formed at all.

Apply thermal energy to sub-lines according to the disclosure can apply thermal energy to sub-lines on a thermally activated print media to cause color formation on the thermally activated print media. Application of thermal energy to different sub-lines can allow for the formation of various colorant density levels of sub-lines in order to produce consistent colors in lines of the thermally activated print media during colorant startup. By applying thermal energy to sub-lines, the thermal printer can form sub-lines at different colorant density levels than others, which can result in color formation on thermally activated print media that may not be affected by variation between different thermal printers, between layers of the thermally activated print medium, and/or by outside factors such as relative humidity. Undesired effects, such as blown up highlights, can be avoided.

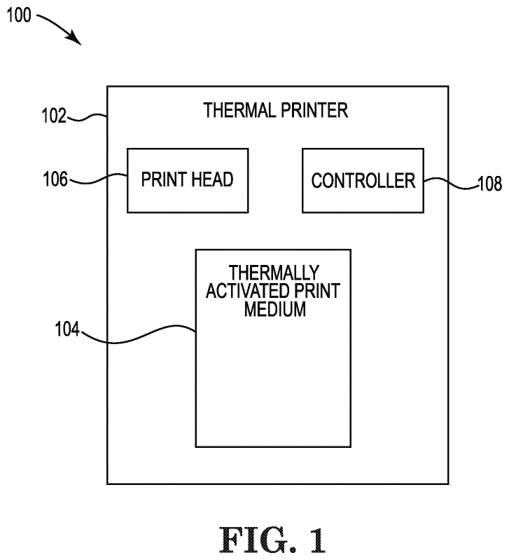

FIG. 1 is a diagram of an example system 100 to apply thermal energy to sub-lines consistent with the disclosure. As illustrated in FIG. 1, system 100 can include thermal printer 102. Thermal printer 102 can include print head 106, controller 108, and thermally activated print medium 104.

As illustrated in FIG. 1, thermal printer 102 can include print head 106. As used herein, the term “print head” refers to a component in a thermal printer that causes physical representations, such as text, images, etc., to occur on a thermally activated print medium.

Print head 106 of thermal printer 102 can apply thermal energy to thermally activated print medium 104 to cause text, images, etc, to form on thermally activated print medium 104. For example, print head 106 can form markings on thermally activated print medium 104 by applying thermal energy (e.g., heat) to portions of thermally activated print medium 104. Collectively, the portions to which thermal printer 102 applies thermal energy on thermally activated print medium 104 can comprise the physical representation of images, text, etc.

The thermal printer 102 can apply heat to the portions of thermally activated print medium 104, which can be referred to as lines. As used herein, the term “line” refers to a portion of thermally activated print medium 104 to which thermal printer 102 can apply heat. The lines of thermally activated print medium 104 can be in a horizontal orientation in an X-direction, a Y-direction, or at some angle between the X-direction and Y-direction relative to the plane of thermally activated print medium 104 according to a two-dimensional cartesian coordinate system. As described above, collectively, the lines to which thermal printer 102 applies thermal energy can comprise the physical representation of the print data (e.g., text, images, etc.).

As discussed above, in order to activate the various layers of thermally activated print medium 104, print head 106 can apply thermal energy for different durations. The application of thermal energy for different durations can cause various layers of thermally activated print medium 104 to activate. As used herein, the term “activate” refers to a layer (e.g., a color) of thermally activated print medium 104 developing a color as a result of the temperature applied to thermally activated print medium 104 by print head 106.

As illustrated in FIG. 1, thermal printer 102 can include controller 108. Controller 108 can receive print data about a line to be formed on thermally activated print medium 104 by print head 106. As used herein, the term “print data” refers to information relating to a physical representation to be printed on thermally activated print medium 104. For example, print data can include a colorant density level of lines of thermally activated print medium 104, a temperature of the thermal energy to be applied to thermally activated print medium 104 at a particular line of thermally activated print medium 104, and/or a duration of the thermal energy to be applied to thermally activated print medium 104 at the particular line of thermally activated print medium 104, among other types of print data. Controller 108 can receive print data from, for example, a computing device, although examples of the disclosure are not so limited.

For example, controller 108 can receive print data corresponding to a physical representation to be formed on thermally activated print medium 104 of a representation of a tree having leaves and a blue sky background. The print data can include colorant density levels of lines that collectively make up the physical representation of the tree on thermally activated print medium 104, as well as temperatures and durations of thermal energy applications to the lines that collectively make up the physical representation of the tree. In some examples, the values of amounts of color can be represented by an 8-bit value.

Although controller 108 is illustrated in FIG. 1 as being included in thermal printer 102, examples of the disclosure are not so limited. For example, controller 108 can be remote from thermal printer 102 and can communicate with thermal printer 102 via a network relationship, such as a wired or wireless network.

Controller 108 can divide a line of thermally activated print medium 104 into a plurality of sub-lines. For example, controller 108 can divide portion of thermally activated print medium 104 to which thermal printer 102 can apply heat into a plurality of sub-portions to which thermal printer 102 can apply heat to thermally activated print medium 104. Print head 106 can apply thermal energy to the various sub-lines in order to produce a particular overall colorant density level of the line as a whole, as is further described herein, As used herein, the term “colorant density level” refers to an amount of colorant in a particular printing area. In the print data, the colorant density level can be described by an 8-bit integer value. The integer value can utilize a 0 to 255 range to describe the colorant density level. For example, an integer value of 220 would represent a higher colorant density level and would result in a darker color than an integer value of 30, which would represent a lower colorant density level and would result in a lighter color,

The term “overall colorant density level of the line” refers to a colorant density level of the sub-lines of the line such that, when viewed together, results in a particular color. For instance, in one example, two sub-lines having a dark blue color, with a white sub-line located between the two dark blue sub-lines, can result in an overall colorant density level such that, when the three sub-lines are viewed together, produces a light blue color, as is further described herein.

In some examples, controller 108 can divide the line into a plurality of sub-lines. For instance, controller 108 can divide the line into three sub-lines. Thermal printer 102 can apply thermal energy to particular sub-lines of the three sub-lines of thermally activated print medium 104 to increase the colorant density level of the sub-lines based on the received print data, as is further described herein. As described above, the colorant density levels of the first sub-line and the third sub-line can be higher than the second sub-line. Further, the second sub-line of the three sub-lines can be located between the first sub-line and the third sub-line.

Although controller 108 is described as dividing the line into three sub-lines, examples of the disclosure are not so limited. For example, controller 108 can divide the line into less than three sub-lines (e.g., two sub-lines), or divide the line into more than three sub-lines (e.g., four or more sub-lines).

Continuing with the example above, controller 108 can determine a threshold colorant density level of each sub-line of the plurality of sub-lines. For example, controller 108 can determine a threshold colorant density level of the first sub-line, the second sub-line, and/or the third sub-line. The threshold colorant density levels of the sub-lines can be described by an 8-bit integer value, similar to the overall colorant density level of the line. For instance, based on the print data, controller 108 can determine a threshold colorant density level of the first sub-line, the second sub-line, and the third sub-line, where the print data indicates that the second sub-line includes a lower colorant density level than the first sub-line and the third sub-line. As described above, a line may be included in the tree having leaves and a blue sky which has a light blue color. Controller 108 can determine the threshold colorant density level of the first sub-line to be an integer value of 24, the second sub-line to be an integer value of 0, and the third sub-line to be an integer value of 24 such that, when the line is viewed as a whole, produces a light blue color for the blue sky, as is further described herein.

Print head 106 can apply thermal energy to the first sub-line and the third sub-line on thermally activated print medium 104 using the received print data. Application of thermal energy to the first sub-line and the third sub-line can cause colors to form in the sub-lines on thermally activated print medium 104. As the temperature and duration of the thermal energy applied to the sub-lines of thermally activated print medium 104 are varied, varying colorant density levels of the first sub-line and the third sub-line can be achieved. The varying colorant density levels can be described as a threshold colorant density level, as is further described herein.

Print head 106 can apply thermal energy to the first sub-line on the thermally activated print medium 104 for a particular duration and particular temperature such that a threshold colorant density level of the first sub-line is reached. For example, the threshold colorant density level of the first sub-line can be determined by controller 108 to be the 8-bit integer value of 24. Print head 106 can apply thermal energy to the first sub-line for the particular duration and the particular temperature (e.g., included in the print data) to cause the first sub-line to form a colorant density level described by the 8-bit integer value of 24.

Similarly, print head 106 can apply thermal energy to the third sub-line on the thermally activated print medium 104 for a particular duration and particular temperature such that a threshold colorant density level of the third sub-line is reached. For example, the threshold colorant density level of the third sub-line can be determined by controller 108 to be the 8-bit integer value of 24. Print head 106 can apply thermal energy to the third sub-line for the particular duration and the particular temperature (e.g., included in the print data) to cause the third sub-line to form a colorant density level described by the 8-bit integer value of 24. Print head 106 can apply thermal energy to the third sub-line on the thermally activated print medium 104 in response to the threshold colorant density level of the first sub-line having been reached. Print head 106 can refrain from applying thermal energy to the second sub-line, since the colorant density level of the second sub-line is determined to be the 8-bit integer value of 0.

As previously described, the thermally activated print medium 104 can include layers, which can correspond to different colors. For instance, the top layer of thermally activated print medium 104 can be yellow, the medium layer can be magenta, and the bottom layer can be cyan. The print head 106 can apply thermal energy at various temperatures for various durations to activate the various layers of thermally activated print medium 104. The various temperatures for various durations to activate the various layers of thermally activated print medium 104 can be included in the print data.

In some examples, the print data can include instructions to form a yellow color on thermally activated print medium 104. Continuing with the example from above, the print head 106 can apply thermal energy to the first sub-line at a temperature and duration included in the print data to activate the yellow layer of thermally activated print medium 104. The print head 106 can apply thermal energy at a particular temperature for a particular duration to cause the threshold colorant density of the first sub-line to be reached. Print head 106 can then apply thermal energy to the third sub-line at a particular temperature and particular duration included in the print data to activate the yellow layer of thermally activated print medium 104 such that the threshold colorant density of the third sub-line is reached.

In some examples, the print data can include instructions to form a magenta color on thermally activated print medium 104. Similarly, the print head 106 can apply thermal energy to the first sub-line at a temperature and duration included in the print data to activate the magenta layer of thermally activated print medium 104. The print head 106 can apply thermal energy at a particular temperature for a particular duration to cause the threshold colorant density of the first sub-line to be reached. Print head 106 can then apply thermal energy to the third sub-line at a particular temperature and particular duration included in the print data to activate the magenta layer of thermally activated print medium 104 such that the threshold colorant density of the third sub-line is reached.

In some examples, the print data can include instructions to form a cyan color on thermally activated print medium 104. Similarly, the print head 106 can apply thermal energy to the first sub-line at a temperature and duration included in the print data to activate the cyan layer of thermally activated print medium 104. The print head 106 can apply thermal energy at a particular temperature for a particular duration to cause the threshold colorant density of the first sub-line to be reached. Print head 106 can then apply thermal energy to the third sub-line at a particular temperature and particular duration included in the print data to activate the cyan layer of thermally activated print medium 104 such that the threshold colorant density of the third sub-line is reached.

In some examples, the print data can include instructions to form a color having a combination of yellow, magenta, and cyan on thermally activated print medium 104. In such a case, the print data can include instructions to activate a combination of the yellow, magenta, and cyan layers to form the color. The print head 106 can apply thermal energy to the first sub-line at a particular temperature and duration included in the print data to activate the combination of yellow, magenta, cyan layers of thermally activated print medium 104. The print head 106 can apply thermal energy to the yellow, magenta, cyan layers at a particular temperature and duration to cause the threshold colorant density of the first sub-line to be reached. Print head 106 can then apply thermal energy to the third sub-line at a temperature and duration included in the print data to activate the yellow, magenta, cyan layers of thermally activated print medium 104 such that the threshold colorant density of the third sub-line is reached.

Although described above as including the same color for the first sub-line and the third sub-line, examples of the disclosure are not so limited. For example, the first sub-line can be a particular color and the third sub-line can be a different color.

As described above, print head 106 can cause particular sub-lines (e.g., the first sub-line and the third sub-line) to form a color. The first sub-line and the third sub-line can therefore be darker than the remaining (e.g., second sub-line). However, when the line is viewed as a whole (e.g., including the first, second, and third sub-lines), the colorant density level of the line as a whole can be such that the line has a certain color. For example, the first sub-line and the third sub-line can be dark blue (e.g., represented by 8-bit integer values of 24, respectively) while the second sub-line is white (e.g., represented by 8-bit integer value of 0). When the line is viewed as a whole, the line may be viewed as a color that can be represented by a different 8-bit integer value (e.g., 4) such that, while the first and third sub-lines are dark blue and the second sub-line is white, the line as a whole can appear light blue.

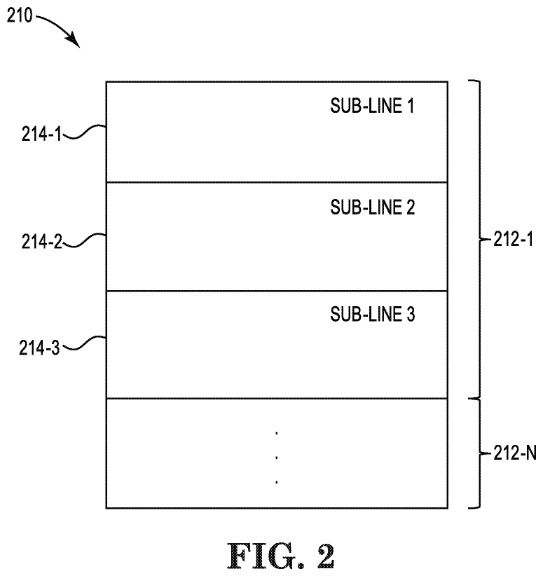

FIG. 2 is a diagram of an example of a thermally activated print medium 210 consistent with the disclosure. As illustrated in FIG. 2, thermally activated print medium 210 can include lines 212-1, 212-N (referred to collectively herein as lines 212. Line 212-1 can include sub-line 1 (e.g., sub-line 214-1), sub-line 2 (e.g., sub-line 214-2), and sub-line 3 (e.g., sub-line 214-3), referred to collectively herein as sub-lines 214.

Print data received by the controller can include an overall colorant density level of the lines of thermally activated print medium 210. For example, print data can include a colorant density level of line 212-1. The colorant density level of line 212-1 can result a light blue color for line 212-1.

As previously described in connection with FIG. 1, a controller can divide line 212-1 into sub-lines. For example, the controller can divide line 212-1 into sub-lines 214-1, 214-2, and 214-3.

The controller can determine a threshold colorant density level of each of the sub-lines 214 based on the received print data. For example, the print data can indicate that line 212-1 should be a light blue color.

Based on the print data, the controller can determine the threshold colorant density level of each sub-line 214 to produce the light blue color, For example, in order to form the intended light blue color of line 212-1, the controller can determine the threshold colorant density level of sub-lines 214-1 and 214-3 to be an integer value of 24.

The print head can apply thermal energy to sub-line 214-1 such that a threshold colorant density level of sub-line 214-1 is reached. For example, the print head can apply thermal energy to sub-line 214-1 at a particular temperature and duration such that the colorant density level of sub-line 214-1 results in an 8-bit integer value of 24.

Similarly, the print head can apply thermal energy to sub-line 214-3 such that a threshold colorant density level of sub-line 214-3 is reached. For example, the print head can apply thermal energy to sub-line 214-3 at a particular temperature and duration such that the colorant density level of sub-line 214-3 results in an 8-bit integer value of 24 (e.g., the threshold colorant density level of sub-line 214-3).

Although the example above describes a threshold colorant density level of 0 for sub-line 214-2 (e.g., the print head skips sub-line 214-2 and does not apply thermal energy to sub-line 214-2), examples of the disclosure are not so limited. For example, the threshold colorant density levels for the sub-lines 214 of line 212-1 can include a threshold colorant density level of 24 for sub-lines 214-1 and 214-3, and a threshold colorant density level of 8 for sub-line 214-2.

In such an example, the print data can include instructions to apply thermal energy to sub-line 214-2. Application of thermal energy to sub-line 214-2 can be done once thermal energy is applied to sub-line 214-1. For example, the print head can apply thermal energy to sub-line 214-1 at a particular temperature and for a particular duration to cause sub-line 214-1 to reach a threshold colorant density level (e.g., 24), then apply thermal energy to sub-line 214-2 at a particular temperature and for a particular duration such that sub-line 214-2 reaches a threshold colorant density level of 8, and then apply thermal energy to sub-line 214-3 at a particular temperature and for a particular duration to cause sub-line 214-3 to reach a threshold colorant density level (e.g., 24). Application of thermal energy to sub-line 214-2 can improve a resolution of line 212-1.

The process described above can be referred to as dithering sub-lines 214. As used herein, the term “dither” refers to juxtaposing two or more colors to create an illusion that another color is present. For example, the print head can dither sub-lines 214 to allow various tone levels to be created in line 212-1 by creating an illusion of continuous tone images on devices with a limited color set. For example, the print head can apply thermal energy to sub-lines 214-1, 214-2, and/or 214-3 to increase the colorant density levels of sub-lines 214 to create various tone levels of line 212-1.

For example, the print head can apply thermal energy to sub-line 214-1 such that the colorant density level of sub-line 214-1 has a value of 24, refrain from applying thermal energy to sub-line 214-2 (e.g., in an example in which sub-line 214-2 has a threshold colorant density level of 0), and then apply thermal energy to sub-line 214-3 such that the colorant density level of sub-line 214-3 has a value of 24.

The print head can dither sub-lines 214 based on the print data received by the controller. For example, the color tones generated by having the colorant density level of sub-lines 214-1 and 214-3 having a value of 24, while the colorant density level of sub-line 214-2 has a value of 0 may be the color tone included in the print data received by the controller.

Although threshold colorant density level of sub-lines 214 is described above as being an integer value of 12, examples of the disclosure are not so limited. For example, the threshold colorant density level of sub-lines 214 can be any other integer value between 0 and 255. Further, the threshold colorant density level of sub-lines 214 can be different for different sub-lines. For example, sub-line 214-1 can include a threshold colorant density level that is different from sub-line 214-2 and/or 214-3.

Application of thermal energy to form sub-lines in this manner can allow for consistent color formation on the thermally activated print medium. For example, dividing a line into sub-lines and applying thermal energy to the sub-lines in a dithering fashion such that the sub-lines reach a threshold colorant density level can produce consistent colors during colorant startup. Additionally, the color formation may not be affected by variations between thermal printers, layers of the thermally activated print medium, and/or outside factors such as relative humidity, allowing for certain undesired effects to be avoided.

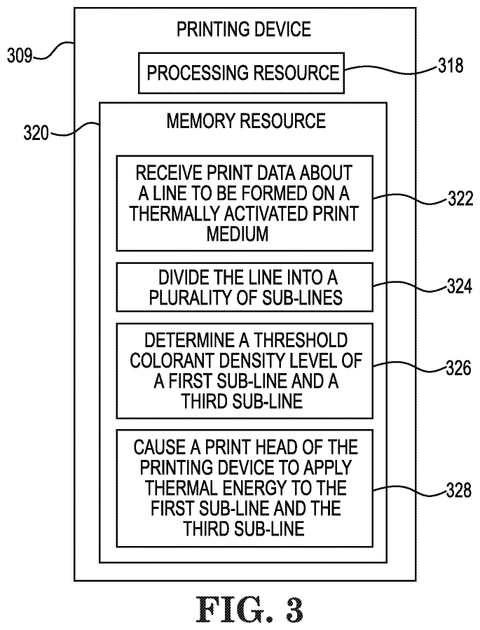

FIG. 3 is a diagram of an example printing device 309 to apply thermal energy to sub-lines consistent with the disclosure. As described herein, the printing device 309 may perform a number of functions related to applying thermal energy to sub-lines. Although not illustrated in FIG. 3, the printing device 309 may include a processor and a machine-readable storage medium. Although the following descriptions refer to a single processor and a single machine-readable storage medium, the descriptions may also apply to a system with multiple processors and multiple machine-readable storage mediums. In such examples, the printing device 309 may be distributed across multiple machine-readable storage mediums and the printing device 309 may be distributed across multiple processors. Put another way, the instructions executed by the printing device 309 may be stored across multiple machine-readable storage mediums and executed across multiple processors, such as in a distributed or virtual computing environment,

As illustrated in FIG. 3, the printing device 309 may comprise a processing resource 318, and a memory resource 320 storing machine-readable instructions to cause the processing resource 318 to perform a number of operations relating to applying thermal energy to sub-lines. That is, using the processing resource 318 and the memory resource 320, the printing device 309 may cause a print head of a thermal printer to apply thermal energy to a sub-line, among other operations. Processing resource 318 may be a central processing unit (CPU), microprocessor, and/or other hardware device suitable for retrieval and execution of instructions stored in memory resource 320.

The printing device 309 may include instructions 322 stored in the memory resource 320 and executable by the processing resource 318 to receive print data about a line to be formed on a thermally activated print medium. The print data can include a colorant density level of lines of the thermally activated print medium, a temperature of the thermal energy to be applied to the thermally activated print medium at a particular line of thermally activated print medium 104, and/or a duration of the thermal energy to be applied to the thermally activated print medium at the particular line of thermally activated print medium, among other types of print data.

The printing device 309 may include instructions 324 stored in the memory resource 320 and executable by the processing resource 318 to divide the line into a plurality of sub-lines. For example, the printing device 309 can divide the line into two sub-lines, three sub-lines, four sub-lines, etc.

The printing device 309 may include instructions 326 stored in the memory resource 320 and executable by the processing resource 318 to determine a threshold colorant density level of a first sub-line and a third sub-line. That is, the printing device 309 may include instructions 326 stored in the memory resource 320 and executable by the processing resource 318 to determine a threshold colorant density level of the first sub-line and third sub-line of the plurality of sub-lines based on the received print data.

The printing device 309 may include instructions 328 stored in the memory resource 320 and executable by the processing resource 318 to cause a print head of the printing device 309 to apply thermal energy to the first sub-line and the third sub-line. That is, the printing device 309 may include instructions 328 stored in the memory resource 320 and executable by the processing resource 318 to cause a print head of a thermal printer to apply thermal energy to the first sub-line and the third sub-line on the thermally activated print medium using the received print data. Thermal energy can be applied to the first sub-line at a particular temperature and for a particular duration such that the first sub-line reaches a threshold colorant density level. Similarly, thermal energy can be applied to the third sub-line at a particular temperature and for a particular duration such that the third sub-line reaches a threshold colorant density level.

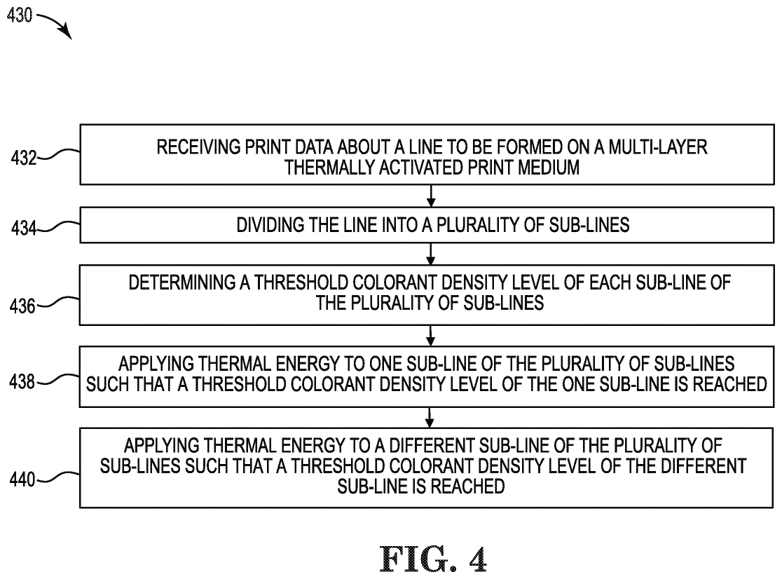

FIG. 4 is an example of a method 430 to apply thermal energy to sub-lines consistent with the disclosure. Method 430 may be performed, for example, by a controller (e.g., controller 108, previously described in connection with FIG. 1), and a print head (e.g., print head 106, previously described in connection with FIG. 1) of a printing device (e.g., thermal printer 102, previously described in connection with FIG. 1, printing device 309, previously described in connection with FIG. 3).

At 432, the method 430 may include receiving, by a controller, print data about a line to be formed on a multi-layer thermally activated print medium. The line can be formed by a print head of a thermal printer by application of thermal energy to the multi-layer thermally activated print medium, as is further described herein. The controller can receive print data that can include overall colorant density levels of lines of the thermally activated print medium, a temperature of the thermal energy to be applied to the thermally activated print medium at a particular line of thermally activated print medium 104, and/or a duration of the thermal energy to be applied to the thermally activated print medium at the particular line of thermally activated print medium, among other types of print data.

At 434, the method 430 may include dividing, by the controller, a particular line into a plurality of sub-lines. For example, the controller can divide the line into sub-lines to which the print head of the thermal printer can apply thermal energy.

At 436, the method 430 can include determining, by the controller, a threshold colorant density level of each sub-line of the plurality of sub-lines to reach the overall colorant density level of the line. The colorant density level can be an 8-bit integer value to describe an amount of colorant (e.g., the colorant density level). The threshold colorant density level can describe an amount of colorant to be included in a particular sub-line of the plurality of sub-lines.

At 438, the method 430 can include applying thermal energy, by the print head of the printer, to one sub-line of the plurality of sub-lines at the temperature and duration included in the print data. The print head of the printer can apply thermal energy to the one sub-line at the particular temperature and duration such that a threshold colorant density level of the one sub-line is reached.

At 440, the method 430 can include applying thermal energy, by the print head of the printer in response to the threshold colorant density level of the one sub-line having been reached, to a different sub-line of the plurality of sub-lines at the temperature and duration included in the print data. The print head of the printer can apply thermal energy to the different sub-line at the particular temperature and duration such that a threshold colorant density level of the different sub-line is reached.

Method 430 may be repeated. For example, method 430 may be repeated to apply thermal energy to each of a plurality of lines included on the multi-layer thermally activated print medium such that an overall colorant density level of each of the plurality of lines is reached. For example, each of the plurality of lines can be divided into a plurality of sub-lines, where each sub-line of the plurality of sub-lines can include a threshold colorant density level. The print head can dither the plurality of sub-lines of each of the plurality of lines by applying thermal energy to the plurality of sub-lines such that a threshold colorant density level of each sub-line is reached, causing an overall colorant density level of each of the plurality of lines to be reached. In other words, the method 430 can be repeated until the overall threshold colorant density level of each line included on the thermally activated print medium is reached, resulting in the physical representation (e.g., text, images, etc.) of the print data being formed on the thermally activated print medium.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing.

Elements illustrated in the various figures herein can be added, exchanged, and/or eliminated so as to provide a plurality of additional examples of the disclosure. In addition, the proportion and the relative scale of the elements provided in the figures are intended to illustrate the examples of the disclosure, and should not be taken in a limiting sense. As used herein, the designator “N”, particularly with respect to reference numerals in the drawings, indicate that a plurality of the particular feature so designated can be included with examples of the disclosure. The designator can represent the same or different numbers of the particular features. As used herein, “a plurality of” an element and/or feature can refer to more than one of such elements and/or features.

What is claimed:

1. A printing device comprising:
a processing resource; and
a memory resource storing non-transitory machine-readable instructions to cause the processing resource to:
receive print data about a line to be formed on a thermally activated print medium;
divide the line into a plurality of sub-lines;
determine a threshold colorant density level of a first sub-line and a third sub-line of the plurality of sub-lines based on the received print data; and
cause a print head of the printing device to apply thermal energy to the first sub-line and the third sub-line on the thermally activated print medium using the received print data.

2. The printing device of claim 1, including instructions to cause the print head of the thermal printer to apply thermal energy to the first sub-line on the print medium such that the threshold colorant density level of the first sub-line is reached.

3. The printing device of claim 2, including instructions to, in response to the threshold colorant density level of the first sub-line having been reached, cause the print head to apply thermal energy to the third sub-line on the print medium using the received print data such that the threshold colorant density level of the third sub-line is reached.

4. The printing device of claim 1, wherein the plurality of sub-lines includes a second sub-line located between the first sub-line and the third sub-line.

5. The printing device of claim 4, including instructions to, in response to the threshold colorant density level of the first sub-line having been reached, cause the print head to apply thermal energy to the second sub-line on the print medium using the received print data such that the threshold colorant density level of the second sub-line is reached.

6. The printing device of claim 4, wherein a colorant density level of the first sub-line and third sub-line is higher than a colorant density level of the second sub-line.

7. A system, comprising:
a thermal printer including a print head;
a multi-layer thermally activated print medium; and
a controller to:
receive print data about a line to be formed on the multi-layer thermally activated print medium by the print head of the thermal printer, wherein the print data includes a temperature and a duration of thermal energy to be applied to the multi-layer thermally activated print medium;
divide the line into a plurality of sub-lines; and
determine a threshold colorant density level of a first sub-line and a third sub-line of the plurality of sub-lines based on the received print data;
wherein the print head is to apply thermal energy to:
the first sub-line at the temperature and the duration included in the print data such that a threshold colorant density level of the first sub-line is reached; and
the third sub-line at the temperature and the duration included in the print data such that a threshold colorant density level of the third sub-line is reached.

8. The system of claim 7, wherein the multi-layer thermally activated print medium includes a yellow layer, a magenta layer, and a cyan layer.

9. The system of claim 8, wherein the print head is to apply thermal energy to:
the first sub-line at the temperature and the duration included in the print data to activate the yellow layer of the multi-layer thermally activated print medium such that the threshold colorant density level of the first sub-line is reached; and
the third sub-line at the temperature and the duration included in the print data to activate the yellow layer of the multi-layer thermally activated print medium such that the threshold colorant density level of the third sub-line is reached.

10. The system of claim 8, wherein the print head is to apply thermal energy to:
the first sub-line at the temperature and the duration included in the print data to activate the magenta layer of the multi-layer thermally activated print medium such that the threshold colorant density level of the first sub-line is reached; and
the third sub-line at the temperature and the duration included in the print data to activate the magenta layer of the multi-layer thermally activated print medium such that the threshold colorant density level of the third sub-line is reached.

11. The system of claim 8, wherein the print head is to apply thermal energy to:
the first sub-line at the temperature and the duration included in the print data to activate the cyan layer of the multi-layer thermally activated print medium such that the threshold colorant density level of the first sub-line is reached; and
the third sub-line at the temperature and the duration included in the print data to activate the cyan layer of the multi-layer thermally activated print medium such that the threshold colorant density level of the third sub-line is reached.

12. The system of claim 8, wherein the print head is to dither he sub-lines of the plurality of sub-lines.

13. A method, comprising:
receiving, by a controller, print data about a line to be formed on a multi-layer thermally activated print medium by a print head of a thermal printer, wherein the print data includes an overall colorant density level of the line, a temperature, and a duration of thermal energy to be applied to the multi-layer thermally activated print medium;
dividing, by the controller, the line into a plurality of sub-lines;
determining, by the controller, a threshold colorant density level of each sub-line of the plurality of sub-lines to reach the overall colorant density level of the line;
applying thermal energy, by the print head of the thermal printer, to one sub-line of the plurality of sub-lines at the temperature and the duration included in the print data such that a threshold colorant density level of the one sub-line is reached; and
applying thermal energy, by the print head of the thermal printer in response to the threshold colorant density level of the one sub-line having been reached, to a different sub-line of the plurality of sub-lines at the temperature and the duration included in the print data such that a threshold colorant density level of the different sub-line is reached.

14. The method of claim 13, wherein the method includes applying thermal energy to one sub-line of the plurality of sub-lines to form at least one of a yellow, magenta, and cyan colorant.

15. The method of claim 13, wherein the method is repeated to apply thermal energy to each of a plurality of lines of the multi-layer thermally activated print medium such that an overall colorant density level of each of the plurality of lines is reached.
